(19) United States
(12) Patent Application Publication
(10) Pub. No.: US 2018/0107943 A1
(43) Pub. Date: Apr. 19, 2018

(54) PERIODIC STRESS TRACKING

(71) Applicant: Microsoft Technology Licensing, LLC, Redmond, WA (US)

(72) Inventors: Ryen William White, Woodinville, WA (US); Gerrit Hofmeester, Woodinville, WA (US); William Voss, Seattle, WA (US); Jason Anthony Grieves, Bellevue, WA (US); Girish Sthanu Nathan, Sammamish, WA (US)

(73) Assignee: Microsoft Technology Licensing, LLC, Redmond, WA (US)

(21) Appl. No.: 15/295,817

(22) Filed: Oct. 17, 2016

(51) Int. Cl. G06N 99/00; G06Q 10/10

(52) U.S. Cl. CPC G06N 99/005; G06Q 10/1093

(57) ABSTRACT

A wearable device includes one or more biometric sensors configured to determine biometric data of a wearer of the wearable device and a stress assessment tool. The stress assessment tool is configured to determine a periodic stress score, via a machine-learning model, based at least on the biometric data, visually present, via a display associated with the wearable device, a graphical user interface (GUI) including the periodic stress score, receive wearer feedback evaluating the accuracy of the periodic stress score, adjust the machine-learning model based on the wearer feedback, determine a reassessed periodic stress score, via the machine-learning model, and visually present, via the display, the reassessed periodic stress score in the GUI.

### BACKGROUND

Electronic devices, such as wearable devices and mobile devices, may be configured to track and output information regarding physiological and behavioral characteristics of a user. Such information may be derived from various signals measured by sensors of the electronic devices as well as other sources.

### SUMMARY

A wearable device is provided that includes one or more biometric sensors configured to determine biometric data of a wearer of the wearable device and a stress assessment tool. The stress assessment tool is configured to determine a periodic stress score via a machine-learning model based at least on the biometric data, visually present via a display associated with the wearable device a graphical user interface (GUI) including the periodic stress score, receive wearer feedback evaluating the accuracy of the periodic stress score, adjust the machine-learning model based on the wearer feedback, determine a reassessed periodic stress score, via the machine-learning model, and visually present, via the display, the reassessed periodic stress score in the GUI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A-1C show an example wearable device visually presenting a periodic stress score of a wearer of the wearable device as well as other stress-related information.

FIGS. 2A and 2B show an example wearable device that may be used for periodic stress score assessment.

FIG. 3 shows a block diagram of an example use environment for periodic stress score assessment.

FIG. 4 shows a block diagram of an example linear-regression machine-learning model configured to determine a periodic stress score.

FIG. 5 shows a wearable device and a mobile device each visually presenting stress-related information for a wearer collected by the wearable device and the mobile device.

FIG. 6 shows a mobile device visually presenting different intervention activities to change a wearer's periodic stress score.

FIG. 7 shows a wearable device visually presenting a reminder to perform an intervention activity.

FIG. 8 shows a mobile device visually presenting a visual representation of an effect of an intervention activity on a wearer's periodic stress score.

FIG. 9 shows a mobile device visually presenting a map including visual markers indicating the one or more stress-related locations.

FIGS. 10A and 10B show an example method of providing a periodic stress score.

### DETAILED DESCRIPTION

As mentioned above, various electronic devices, such as wearable devices or mobile devices, may be configured to track physiological and behavioral characteristics of a user based on data from various sensors of the devices. For example, wearable devices may comprise biometric sensors, such as sensors useable to detect heart rate and heart rate variation, blood pressure, blood oxygenation, skin temperature, and galvanic skin response, as non-limiting examples. Such biometric data may help a user to understand instantaneous health status, as well as to determine trends in the user's health characteristics over time, in another example, a mobile device may include location sensors and motion sensors to track movements of the user over time. Such movement may be used to determine movement data such as calories burned, distance traveled, average speed traveled, and inactive time information. Further, such movement data may be used to determine activity data such as sleep activities, workout activities, places visited (e.g., work, school, home), and people met/meetings attended. However, such devices are unable to leverage this information to provide insight into factors that relate to stress of the user. Moreover, such devices are unable to provide stress information that is tunable based on user feedback.

Accordingly, examples are disclosed herein that relate to a wearable device configured to provide a periodic stress score of a wearer of the wearable device. The periodic stress score is an assessment of stress of the wearer for a defined period (e.g., hourly, daily, weekly). The periodic stress score is determined based on data representing various aspects of the wearer tracked over time. As such, the periodic stress score differs from an instantaneous assessment of stress. As described in more detail below, data from one or more sensors associated with the wearable device may be used by a machine-learning model to determine the periodic stress score of the wearer. The wearable device may be configured to visually present a graphical user interface (GUI) that includes the periodic stress score. Further, the GUI may allow the wearer to interactively provide feedback to adjust the periodic stress score to reflect actual perceived stress of the wearer. The wearable device may be configured to adjust the machine-learning model based on the wearer feedback such that the machine learning model determines a reassessed periodic stress that is in tune with the perceived stress of the wearer. By providing a periodic stress score that is tuned based on wearer feedback, the wearer's periodic stress score may he accurately assessed over time.

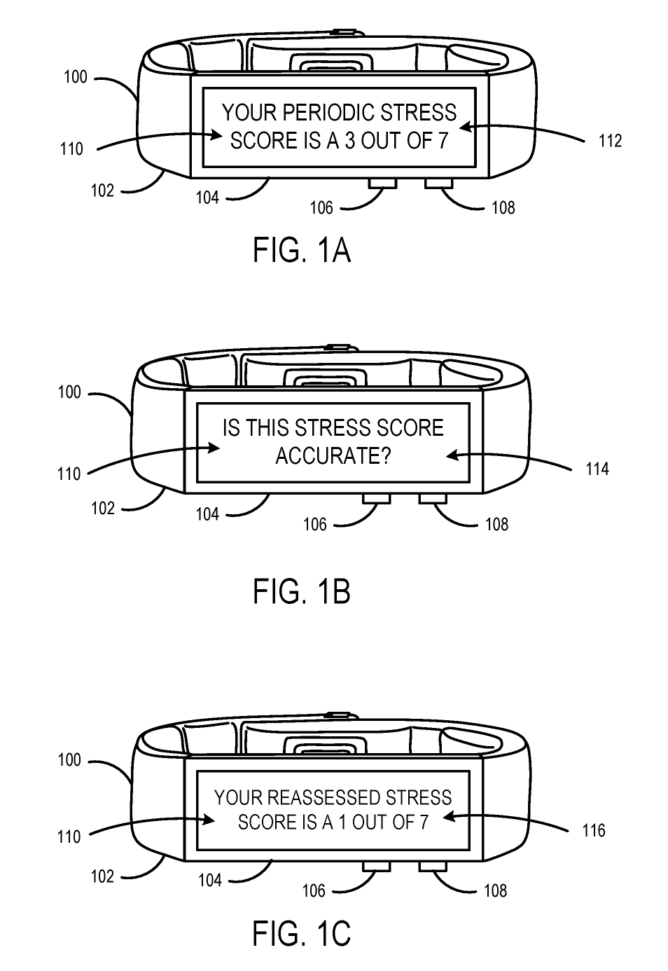

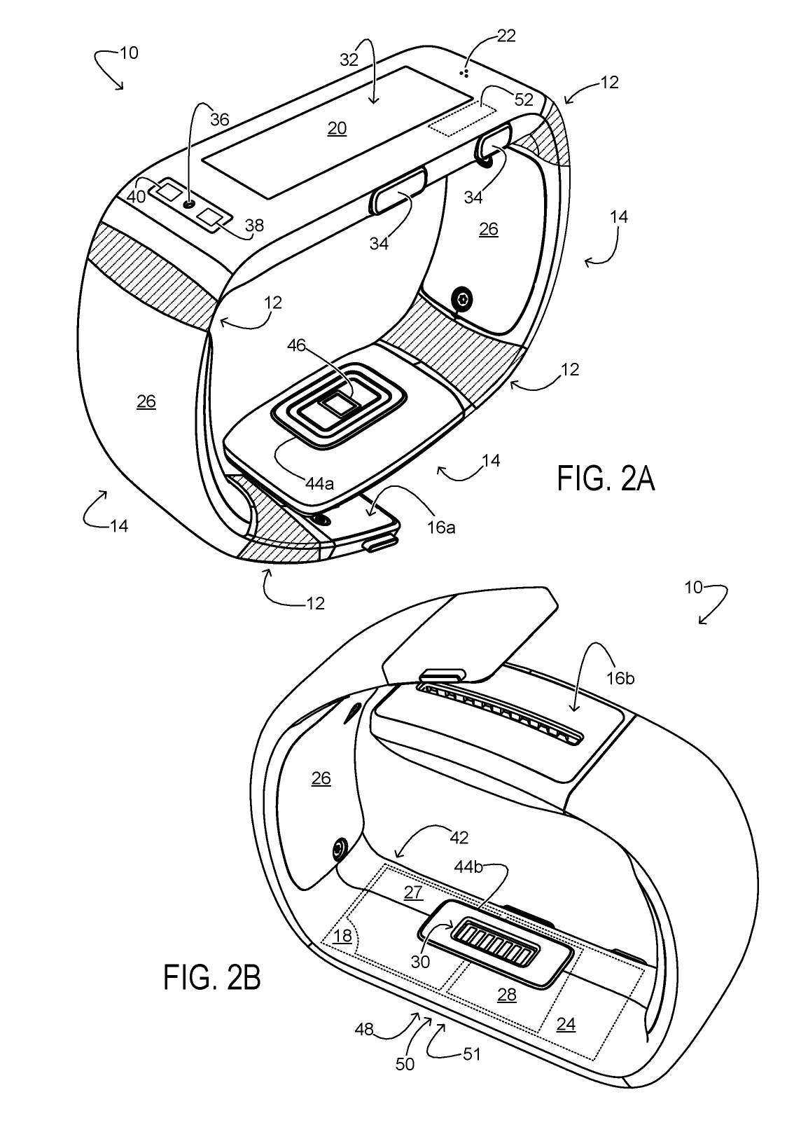

FIGS. 1A-1C show an example wearable device 100. Wearable device 100 is a wrist-worn computing device that includes a wrist band 102 and a display 104. Wrist band 102 is configured to be wrapped around a wrist of a wearer to secure the wearable device 100 to the wearer's wrist. Display 104 is configured to visually present information related to a variety of different application programs executable by wearable device 100. In some implementations, display 104 includes a touch-screen sensor configured to receive touch input from the user. As examples, the touch sensor may be resistive, capacitive, or optically based.

Wearable device 100 includes push buttons 106 and 108. User input from push buttons 106 and 108 may initiate various operations, such as displaying a home-screen, enacting an on-off feature, controlling audio volume, visually presenting and/or executing different application programs, performing application-specific operations, visually presenting application-specific information, adjusting various settings and performing other computing operations.

Wearable device 100 may be configured to execute different application programs related to different activities. Wearable device 100 visually presents a graphical user interface (GUI) 110 via display 104 that allows the wearer to interact with the different application programs. In one example where the display 104 is touch sensitive, the wearer may swipe left or right along display 104 to scroll through a list of different tiles visually presented in the GUI 110 and representing different application programs executable by wearable device 100. Further, the wearer may tap a particular tile that is visually presented in the GUI 110 to execute a corresponding application program. Wearable device 100 may be configured to execute different application programs related to different activities. In some implementations, various application programs may be pre-loaded onto wearable device 100 by a manufacturer of wearable device 100. In some implementations, various application programs can be downloaded to wearable device 100 via communication with a remote computing device.

In the depicted example, wearable device 100 executes a health application program that visually presents stress-related information in the GUI 110. In FIG. 1A, wearable device 100 visually presents a periodic stress score 112 in the GUI 110. The periodic stress score 112 may be determined by a machine-learning model employed by a stress assessment tool of the wearable device 100. In particular, the machine-learning model may use signals from different sources associated with the wearer to determine the periodic stress score 112. For example, biometric data and/or activity data of the wearer may be used by the machine-learning model to determine the periodic stress score 112 as will be discussed in further detail below.

In the illustrated example, the periodic stress score 112 is a “3 out of 7.” The periodic stress score is selected from a scale of different, predetermined stress scores. In particular, the scale of stress scores ranges from a low stress score of 1 to a high stress score of 7. The scale may include a number of different stress scores. In other examples, the periodic stress score need not have a discrete scale. In one alternative example, the periodic stress score is visually represented by a sliding metric having continuous values. In another example, the periodic stress score is visually represented in binary form—e.g., “stressed” vs. “not stressed.” Moreover, the periodic stress score may be visually presented in the GUI 110 via various sorts of different visual indicators. For example, the periodic stress score may be visually represented using different letters, numbers, ratios, percentages, colors, patterns, and, shapes.

Wearable device 100 may determine and/or visually present the periodic stress score 112 according to different periods. In one example, wearable device 100 determines and/or visually presents the periodic stress score 112 on a daily basis. Additionally or alternatively, wearable device 100 may be configured to deter and/or visually present the periodic stress score 112 based on user input. In another example, wearable device 100 determines and/or visually presents the periodic stress score 112 responsive to a trigger, such as either of push buttons 106 or 108 being pressed.

In FIG. 1B, wearable device 100 visually presents a request 114 for wearer feedback in the GUI 110. The wearer feedback may evaluate the accuracy of the periodic stress score 112. The request 114 may be visually presented in the GUI 110 at different times, according to different period, and/or based on different operating conditions of wearable device 100. In one example, the request 114 for wearer feedback is visually presented subsequent to each occurrence of the periodic stress score 112 being visually presented. In another example, the request 114 is visually presented periodically (e.g., on an hourly/daily/weekly/monthly basis). In some implementations, wearer feedback may be requested in other ways. In one example, wearer feedback may be requested via a text (e.g., SMS) message. Such a text message may be sent to wearable device 100 and/or another device associated with the wearer, such as a smartphone, a laptop computer, or a desktop computer.

Subsequent to visually presenting the request 114, wearable device 100 may receive wearer feedback that evaluates the accuracy of the periodic stress score 112. Wearer feedback may he provided in different forms. For example, wearer feedback may include manual adjustment of the periodic stress score to a different stress score. In one example, the wearer may increment the periodic stress score 112 via button 108 and decrements the periodic stress score 112 via button 106. In another example, the wearer may respond to a text message that requests wearer feedback with an actual perceived stress score.

Wearable device 100 may be configured to adjust the machine-learning model that determines the periodic stress score 112 based on the wearer feedback in order to provide a reassessed periodic stress score that is aligned with the perceived stress level of the wearer. In one example, different features of the machine-learning model have different weights or coefficients that affect how the periodic stress score is determined, and the different weights or coefficients may be adjusted based on the wearer feedback. The machine-learning model may be repeatedly adjusted over time based on feedback provided by the wearer to minimize the error between the assessed stress score and the actual perceived stress score of the wearer. Such repeated adjustment may allow the machine-learning model to account for any changes in the way that the wearer perceives stress over time.

In FIG. 1C, wearable device 100 visually presents a reassessed periodic stress score 116 in the GUI 110. The reassessed periodic stress score 116 may be determined by the machine-learning model subsequent to adjustment of the machine-learning model based on wearer feedback. The reassessed periodic stress score 116 may be determined by the machine-learning model using updated/current inputs (e.g., current biometric data, activity data). The reassessed periodic stress score 116 may be determined/reassessed and/or visually presented according to different times, periods, and/or operating conditions of the wearable device 100.

In the illustrated example, the periodic stress score is reduced from a “3 out of 6” to a “1 out of 6” based on the adjustment of the machine-learning model. In this scenario, the wearer indicated via feedback that their perceived/actual stress level is lower than a stress level indicated by the originally assessed periodic stress score 112. Accordingly, the reassessed periodic stress score 116 is tuned to more accurately represent the wearer's perceived stress level. Note that this scenario is meant to be non-limiting, and the reassessed periodic stress score 116 may increase or decrease based on the wearer's feedback/adjustment of the machine-learning model in combination with the updated inputs to the machine-learning model.

The inputs to the machine-learning model, such as the biometric data and the activity data, may be obtained from various sources. For example, biometric data and activity data may be determined from sensor data acquired via a wearable or portable sensor system. FIGS. 2A and 2B show aspects of an example sensory-and-logic system in the form of a wearable electronic device 10 that may be configured to track biometric data and the activity data, and/or provide sensor data (raw or processed) to a remote device, such as a mobile or desktop computing device, for analysis. Wearable electronic device 10 is an example of wearable device 100 of FIGS. 1A-1C.

The illustrated device 10 is band-shaped and may be worn around a wrist. The depicted wearable electronic device 10 includes a plurality of flexion regions 12 linking less flexible regions 14. The flexion regions 12 of the wearable electronic device 10 may be elastomeric in some examples. Fastening componentry 16a and 16b is arranged at both ends of the wearable electronic device 10. The flexion regions 12 and fastening componentry 16a and 16b enable the wearable electronic device 10 to be closed into a loop and to be worn on a user's wrist. In other examples, wearable electronic devices of a more elongate band shape may be worn around the user's bicep, waist, chest, ankle, leg, head, or other body part. In such an example, a wearable electronic device may take the form of eye glasses, a head band, an arm-band, an ankle band, a chest strap, or an implantable device to be implanted in tissue.

The wearable electronic device 10 includes various functional components integrated into less flexible regions 14. For example, the wearable electronic device 10 includes a computing system 18, display 20, loudspeaker 22, communication suite 24, and various sensors. These components draw power from one or more energy-storage cells 26.

In the wearable electronic device 10, the computing system 18 is situated below the display 20 and operatively coupled to the display 20, along with the loudspeaker 22, the communication suite 24, and the various sensors and other components not depicted (e.g. haptic outputs, such as piezoelectric vibrators). The computing system 18 includes a data-storage machine 27 to hold data and instructions, and a logic machine 28 to execute the instructions.

The communication suite 24 may include any appropriate wired or wireless communications componentry. In FIGS. 2A and 2B, the communication suite 24 includes USB port 30, which may be used for exchanging data between the wearable electronic device 10 and other computer systems, as well as providing recharge power. The communication suite 24 may further include two-way Bluetooth, Wi-Fi, cellular, near-field communication and/or other radios. In some examples, the communication suite may include an additional transceiver for optical, line-of-sight (e.g., infrared) communication.

In the wearable electronic device 10, touch-screen sensor 32 is coupled to display 20 and configured to receive touch input from the user. Pushbutton sensors may he used to detect the state of push buttons 34, which may include rockers. Input from the pushbutton sensors may be used to enact a home-key or on-off feature, control audio volume, turn the microphone on or off, etc.

FIGS. 2A and 2B show various other example sensors. Such sensors include microphone 36, visible-light sensor 38, ultraviolet sensor 40, and ambient temperature sensor 42. The microphone 36 provides input to the computing system 18 that may be used to measure the ambient sound level or receive voice commands from the wearer. Input from the visible-light sensor 38, ultraviolet sensor 40, and ambient temperature sensor 42 may be used to assess aspects of the wearer's environment—e.g., the temperature, overall lighting level, and whether the wearer is indoors or outdoors.

FIGS. 2A and 2B further show a pair of contact sensor modules 44a and 44b, which contact the wearer's skin when the wearable electronic device 10 is worn. The contact sensor modules 44a and 44b may include independent or cooperating sensor elements to provide a plurality of sensory functions. For example, the contact sensor modules 44a and 44b may provide an electrical resistance and/or capacitance sensory function responsive to the electrical resistance and/or capacitance of the wearer's skin, and thus may be configured to function as a galvanic skin response sensor. In the illustrated configuration, the separation between the two contact sensors provides a relatively long electrical path length for more accurate measurement of skin resistance compared to a shorter path. Further, in some examples, a skin temperature sensor may be integrated into one or both of contact sensor modules 44a and 44v h to provide measurement of the wearer's skin temperature.

The wearable electronic device 10 may also include motion sensing componentry, such as an accelerometer 48, gyroscope 50, and magnetometer 51. The accelerometer 48 and gyroscope 50 may furnish inertial and/or rotation rate data along three orthogonal axes as well as rotational data about the three axes, for a combined six degrees of freedom. This sensory data can be used to provide a pedometer/calorie-counting function, for example. Data from the accelerometer 48 and gyroscope 50 may be combined with geomagnetic data from the magnetometer 51 to further define the inertial and rotational data in terms of geographic orientation. The wearable electronic device 10 may also include a global positioning system (GPS) receiver 52 for determining the wearer's geographic location and/or velocity. In some configurations, the antenna of the GPS receiver 52 may be relatively flexible and extend into flexion regions 12. Any of the above described sensors may be used to provide biometric data and/or activity data that may be used to determine a wearer's periodic stress score.

The computing system 18, via the sensory functions described herein, is configured to acquire various forms of information about the wearer of the wearable electronic device 10. Such information must be acquired and used with utmost respect for the wearer's privacy. Accordingly, the sensory functions may be enacted subject to opt-in participation of the wearer. In implementations where personal data is collected on the wearable electronic device 10 and transmitted to a remote system for processing, that data may be anonymized. In other examples, personal data may be confined to the wearable electronic device 10, and only non-personal, summary data is transmitted to the remote system.

It will be understood that any other suitable sensors not shown in FIGS. 2A and 2B may be included on the wearable electronic device 10, such as a heart rate monitor, one more optical sensors, a barometer to detect changes in atmosphere pressure, an actigraph/actimetry sensor to monitor sleep behavior, etc. It will further be understood that although FIGS. 2A-2B shows a wearable device, the methods and techniques described herein may be operated on any other suitable computing device, including a desktop computing device, a mobile computing device, other wearable computing devices, and computing devices without sensors that may receive data remotely from a sensory-and-logic device such as wearable electronic device 10.

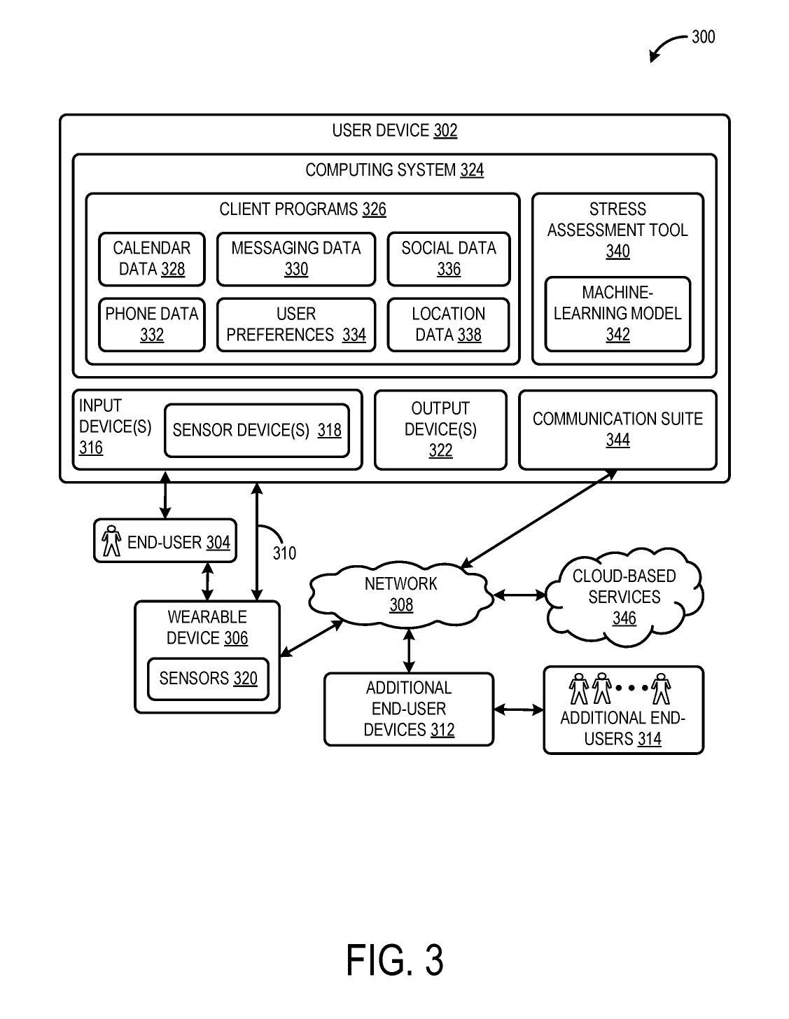

FIG. 3 shows an example use environment 300 including a user device 302 associated with an end-user 304. The user device 302 may be configured to assess a periodic stress score of the end-user 304. For example, user device 302 may take the form of a wearable device, a smartphone, a tablet, a laptop computer, a desktop computer, or another computing device. User device 302 may be configured to communicate with a wearable device 306 via a network 308 and/or a direct connection (e.g., Bluetooth) 310. Device 10 of FIG. 2 is an example of user device 302 and/or a wearable device 306. Additional end-users' device(s) 312, associated with additional end-users 314, may take similar forms.

The user device 302 includes one or more input devices 316, such as a touch sensor (integrated with or separate from a display), a keyboard and/or a mouse. The input devices 316 also may include one or more sensor devices 318. In other examples, a user device may not include sensor devices 318, but may receive sensor data from sensors residing on another device, such as from sensors 320 on wearable device 306. Examples of the wearable device 306 include wrist or ankle-worn devices, head-mounted devices, and clip-on devices, configured to communicate with the user device 302, e.g. via a wired or wireless communication link. The user device 302 also includes one or more output devices 322, such as a display, a speaker, and/or a haptic output mechanism. Examples of sensor devices 318 or sensors 320 include one or more image sensors (e.g. video camera(s) (and/or depth camera(s)), one or more microphones, one or more motion sensors (e.g. accelerometers, gyroscopes, magnetometers, etc.), an ultraviolet light sensor, an ambient temperature sensor, a galvanic skin response sensor, a skin temperature sensor, an optical heart rate sensor, a GPS sensor, and a barometer. Raw output from such sensors may be analyzed, for example by a computing system 324 of the user device 302 or directly on the wearable device 306, to determine biometric data such as user movements, heart rate, blood pressure, blood oxygenation, calories burned, and sleep-related characteristics (e.g., a number of and frequency of wakeups, cardiovascular activity during sleep) as a function of time. Information regarding sleep, exercise, work, interpersonal and other such characteristics may be derived from or correlated with the biometric data to determine activity data of the end-user 304.

Activity data may also be determined or inferred from other suitable data on user device 302. For example, the user device 302 may include client programs 326 including calendar functionality that may reflect calendar data 328 including past, present, and future activities scheduled for end-user 304 in a calendar. The client programs 326 may also provide various messaging data 330, phone data 332, user preferences 334, social data 336, and location data 338. The messaging data 330 may include any type of messages, such as email, text (e.g., SMS), and group chat messages. The messaging data 330 may inform when the end-user 304 may have obligations, e.g. from analysis of the content of text invitations, alerts, reminders, and the like. The phone data 332 may provide similar information, e.g. from conversation or voicemail content. The user preferences 334 may indicate behavioral tendencies of the end-user 304 that can be used to infer activity data. The social data 336 may include social networking relationships, associations, and other information that may be used to derive activity data of the end-user 304. The location data 338 may indicate a geographic location of the end-user 304. For example, location data 338 may be determined from a GPS sensor, cellular triangulation, or another type of location sensing technology. The location data 338 may be used to determine places or venues visited by the end-user 304 as well as motion data of the user.

In addition to sensor data collected by the user device 302, activity data also may be determined based at least partially on user inputs. User inputs may be used, for example, to indicate an activity type being performed, an input activating an application program or operating mode on the user device 302, and/or any other suitable data useable to determine activity data.

The user device 302 may also interact with additional user devices via communication suite 344, such as another wearable device, another mobile device, a desktop personal computing device, a laptop computing device, a game console device, a set-top box device, or a tablet-type computing device, as examples. Additional user devices may provide any other suitable biometric data and/or activity data for use in determining a periodic stress score of the end-user 304. Further, activity data may be determined from other sources such as the end-user's email, work data (e.g., an organization chart), external events (e.g., a news feed), and the end-user's travel patterns.

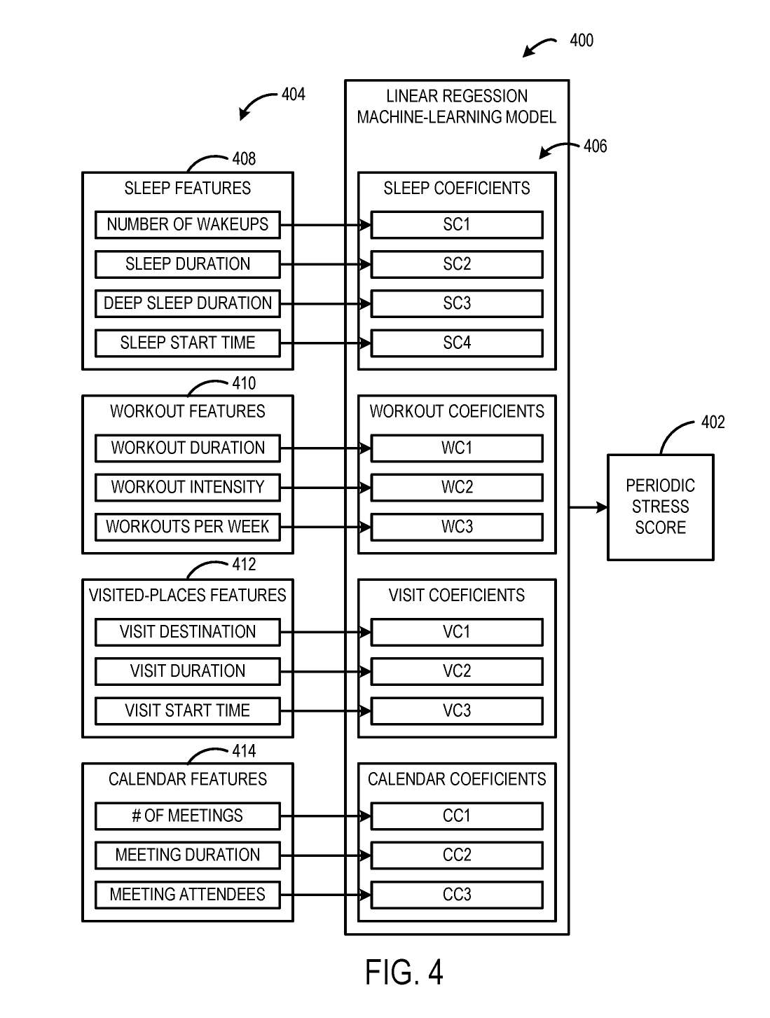

The computing system 324 includes a stress assessment tool 340 configured to determine the periodic stress score of end-user 304 based on the biometric data and/or the activity data. In particular, stress assessment tool 340 is configured to apply the biometric data and/or the activity data to one or more machine-learning models or algorithms 342 to determine the periodic stress score. FIG. 4 shows an example linear-regression machine-learning model 400 configured to determine a periodic stress score 402 from a set of features 404. The linear-regression machine-learning model 400 combines the set of features 404 in a linear equation, the solution to which is the periodic stress score 402. In particular, the linear equation assigns weight or coefficients 406 to the set of features 404. For example, the linear-regression machine-learning model 400 may employ an ordinary least squares procedure to estimate the values of the coefficients. The ordinary least square procedure seeks to minimize the sum of the squared residuals. This means that given a regression line through a set of training data, a square of a distance from each data point to the regression line is calculated, and a sum all of the squared errors is determined. Further, the coefficients may he determined in order to minimize this sum.

The features in the set 404 are derived from the biometric data and the activity data acquired by the user device 302. In particular, the scat of features 404 include sleep features 408, workout features 410, visited-places features 412, and calendar features 414. The sleep features 408 are based on the end-user's sleep behavior and includes a number of wakeups, a sleep duration, a deep-sleep duration, and a sleep start time at which end-user 304 falls asleep. The workout features 410 are based on the end-user's workout behavior and includes a workout duration, a workout intensity (e.g., a value derived from the end-user's heart rate during a workout), and a number of workouts per week. The visited-places features 412 are based on places visited and time spent at those places and includes a type of venue visited, a duration spent at each venue, and a time of day when the venue was visited. The calendar features 414 are based on the end-user's calendar data. For example, such calendar data may include a number of meetings, a duration of each meeting, and a number of additional end-users met with during each meeting, an identification of the end-users attending the meeting, a relationship between the end-users attending the meeting. Such data may be determined from calendar/work data, social networking data, user preferences, and/or other data from client programs 326 of user device 302 of FIG. 3. Each of the features in the set 404 may be a value that is provided as input to the linear-regression machine-learning model 404. The model 400 applies the coefficients 406 to the features 404 and outputs the periodic stress score 402.

The set of features 404 is provided as an example. In some implementations, the machine-learning model 342 may be configured to determine a periodic stress score based on a different set of features. In another example, the machine-learning model 342 may include a plurality of decision tree learners that fit different decision tree models to the set of features 404. For example, a random decision forest regression model may be used by the stress assessment tool 340. In another example, a different machine-learning model may be used by the stress assessment tool 340.

Returning to FIG. 3, the machine-learning model(s) 342 may be trained using training data acquired via supervised learning. In one example, the machine-learning model 342 is trained using a training data including biometric data, activity data, and subjective stress scores provided by a population of the additional end-user 314 and associated devices 312. For example, such training data may be obtained from additional end-users 314 and their devices 312 via cloud-based sen'ices, illustrated schematically at 346.

Furthermore, the stress assessment tool 340 may be configured to adjust the machine-learning model 342 based on feedback from end-user 304 that evaluates the accuracy of the periodic stress score. For example, the feedback may include manual adjustment of the periodic stress score to a different periodic stress score actually perceived by end-user 304. In one example, the stress assessment tool 340 adjusts weights or coefficients of classification features of the machine-learning model 342 based on the feedback in order to minimize an error between the assessed periodic stress score and the actual perceived periodic stress score indicated by end-user 304. Subsequently, when the periodic stress score is reassessed via the machine-learning model, the updated weights or coefficients may be used to determine a reassessed periodic stress score that is accurately tuned based on the perceived stress of end-user 304.

In some implementations, the stress assessment tool 340 may compare characteristics (e.g., age, gender, height, weight, activity level) of end-user 304 to a population of additional end-users 314 to classify end-user 304 in a designated cohort of the population having similar characteristics. End-users in the same cohort having similar biometric data and/or activity data may have similar periodic stress scores. Further, the stress assessment tool 340 may track deviations in the periodic stress score of end-user 304 relative to the typical periodic stress score for the population, and notify end-user 304 of such a deviation. Further, the stress assessment tool 340 may make adjustments to the machine-learning model 342 based on feedback from end-users in the same cohort as the wearer (or from the larger population of additional end-users 314). For example, feedback that is representative of the cohort (e.g., an average periodic stress score) may he used to adjust the machine-learning model 342. For example, such cohort feedback information may be attained by user device. 302 via cloud-based services 346. Likewise, feedback provided by end-user 304 may be aggregated for cohort/population based analysis via cloud-based services 346.

In another example, the stress assessment tool 340 may initially determine the stress of the end-user 304 based on information representing a broad population of end-users, such as a cohort with which the end-user is associated. Further, the stress assessment tool 340 may make adjustments to the machine-learning model 342 to “personalize” the periodic stress score for the end-user 304 as the stress assessment tool 340 collects more data for the end-user 304 over time. Such an approach may address “cold start” issues in order to reduce initially inaccuracies in periodic stress assessment.

In some implementations, the stress assessment tool 340 may be configured to predict a future periodic stress score of end-user 304 based on activity data of end-user 304. In particular, the stress assessment tool 340 may be configured analyze the calendar data 328 to identify activities that are scheduled in the future in the end-user's calendar. Further, the stress assessment tool 340 may he configured to identify features of these future activities, and input the identified features to the machine-learning model 342 to determine a predicted periodic stress score for the end-user 304 based on the future scheduled activity. In some implementations, the machine-learning model 342 may factor in a stress history of end-user 304 to determine the predicted periodic stress score. For example, if the periodic stress score of end-user 304 changed during a previous occurrence of an activity, then the machine-learning model 342 may be adjusted to account for such changes when determining the predicted stress score for a future occurrence of that same activity.

In some implementations, the stress assessment tool 340 and/or the machine-learning model 342 also may be partially or totally incorporated into wearable device 306. In some implementations, wearable device 306 may perform stress-related functionality, such as determining a periodic stress score without any interaction with user device 302.

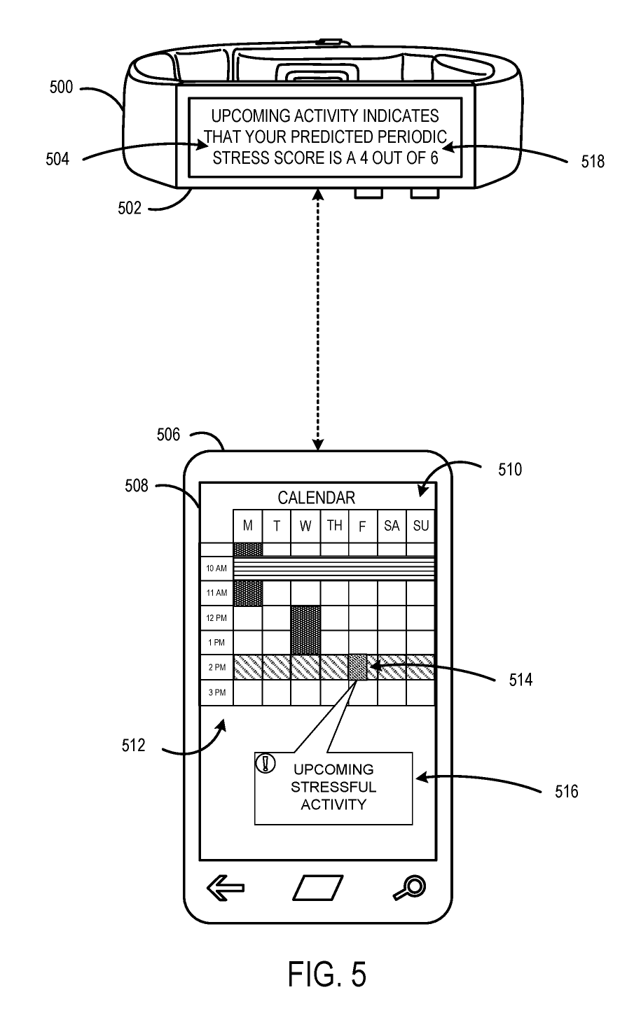

FIG. 5 shows an example scenario in which a predicted periodic stress score is determined based on calendar data. A wearable device 500 includes a display 502 configured to visually present a GUI 504 that includes stress-related information. Wearable device 500 may be in communication with a mobile device 506. The mobile device 506 includes a display 508 configured to visually present a GUI 510 that includes stress-related information. Wearable device 500 and mobile device 506 may be associated with an end-user, such as end-user 304. Wearable device 500 may be an example of wearable device 306 and mobile device 506 may be an example of user device 302 of FIG. 3. Mobile device 506 visually presents, via display 508, a calendar 512 including activities scheduled in the past, present, and future for the end-user in GUI 510. A stress assessment tool of mobile device 506 analyzes the schedule activities to identify an activity 514 that is predicted to affect the periodic stress score of the end user. In this example, the activity is predicted to increase the periodic stress score of the end user. Further, mobile device 506 visually presents, via display 508, a notification 516 indicating that an activity predicted to increase the periodic stress score of the user is upcoming—i.e., an “UPCOMING STRESSFUL ACTIVITY” in GUI 510. For example, the notification 516 may be visually presented based on a prediction that the future activity will affect the periodic stress score by a threshold magnitude. Furthermore, mobile device 506 sends the predicted periodic stress score and/or other stress-related information to wearable device 500. Wearable device 500 visually presents, via display 502, a predicted periodic stress score 518 in GUI 504.

In some implementations, mobile device 506 may be configured to visually present visual representations in the calendar 512 that explain why the periodic stress score of the end-user is high or low. For example, a visual comparison of the days when the end-user had a high periodic stress score and the days when the end-user had a low periodic stress score may be visually presented in the calendar 512. Such a comparison may enable the end-user to learn how different events affect the end-user's periodic stress score, and the end-user may use this tool to help control the end-user's periodic stress score over time. In other words, the end-user may look retrospectively at the previous periodic stress scores and associated data to promote introspection, reflection, and action to control the periodic stress score.

In some implementations, wearable device 500 may be configured to perform some or all of the functionality of mobile device 506. In some such implementations, wearable device 500 need not interact with mobile device 506 to perform such functionality. In other implementations, mobile device 506 may he configured to perform some or all of the functionality of wearable device 500. In some such implementations, mobile device 506 need not interact with wearable device 500. In still other implementations, the herein described functionality may be performed by another computing device. For example, the stress assessment tool may he implemented by a remote computing device, such as a service computing device or a cloud computing device that receives biometric data and/or activity data from the wearable device 500 and/or the mobile device 506. Further, the periodic stress score may be visually presented by a remote computing device, such as via a website.

Because the periodic stress score of end-user 304 is tracked over time by stress assessment tool 340. In some implementations, stress assessment tool 340 may be configured to suggest various intervention activities that may change (i.e., lower) the periodic stress score of end-user 304. Further, stress assessment tool 340 may be configured to track whether end-user 304 performs the intervention activity, and visually present a visual representation of an effect of the intervention activity on the periodic stress score of end-user 304.

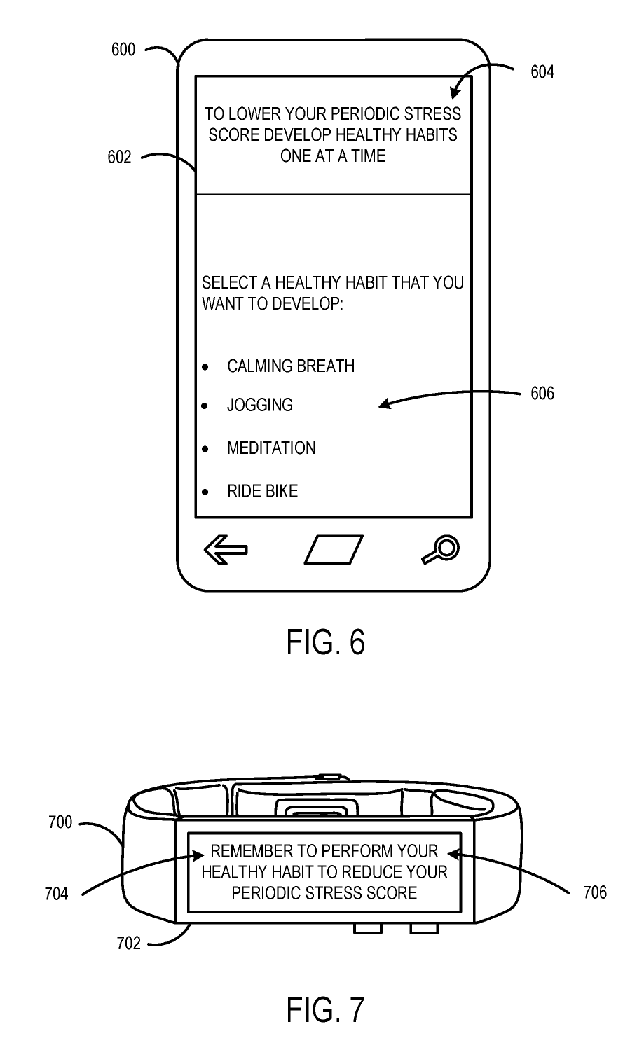

FIGS. 6-8 show an example scenario in which intervention activities are suggested and tracked over time. FIG. 6 shows a mobile device 600 including a display 602 configured to visually present a GUI 604 including a plurality of different intervention activities 606 to reduce a wearer's periodic stress score. For example, the end-user may select one of the intervention activities to perform. An intervention activity may include activities that have an effect on the periodic stress score of the end-user. Non-limiting examples of intervention activities include calming breath, jogging, medication, and riding a bike. Further, a stress assessment tool of mobile device 600 may track that the end-user performs the intervention activity. In some cases, tracking may include determine biometric data and activity data of the end-user while the end-user is performing the intervention activity. In some cases, tracking may include observing that the end-user manually indicated that the end-user performed the intervention activity.

Furthermore, once an intervention activity is selected by the end-user, the end-user may be provided with reminders to repeatedly perform the intervention activity in order to form a healthy habit that may reduce the periodic stress score of the end-user. FIG. 7 shows a wearable device 700 including a display 702 visually presenting a GUI 704 including a reminder notification 707 that reminds the end-user to perform an intervention activity. Wearable device 700 may be configured to visually present reminder 706 according to a period that allows for the end-user to form a habit of repeatedly performing the intervention activity. In one example, reminder 706 is provided on a daily basis. In another example, reminder 706 is provided on a weekly basis.

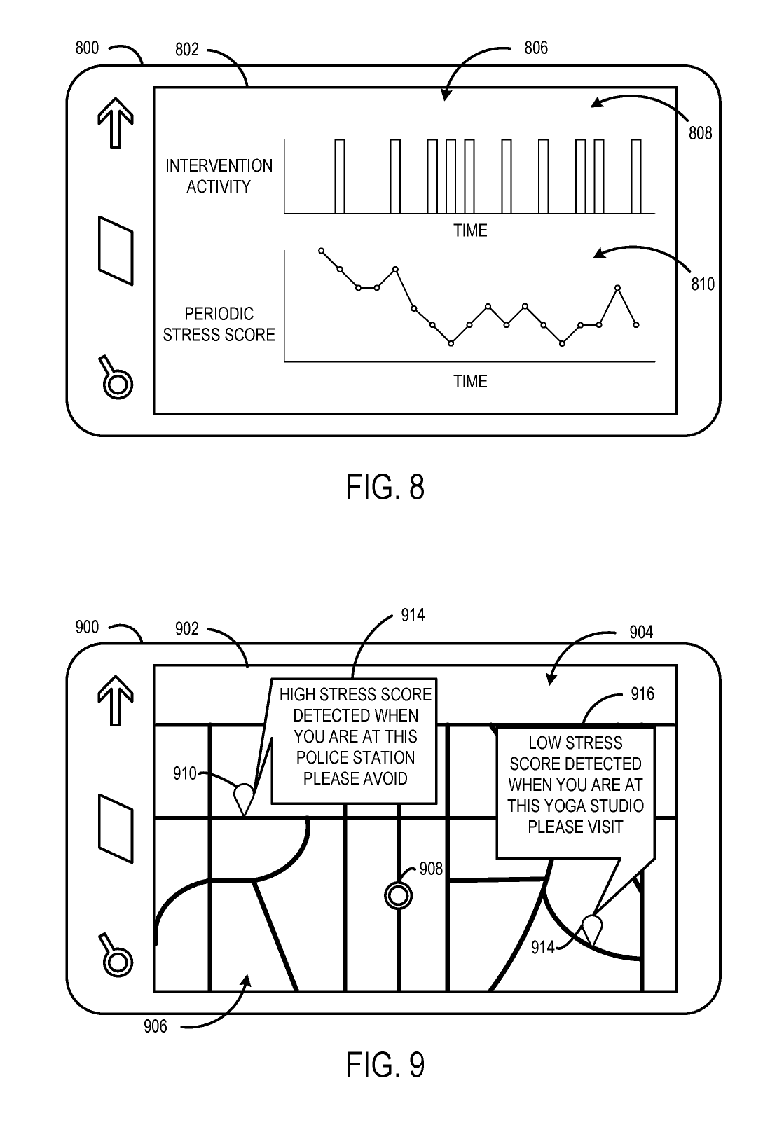

Because the intervention activity and the periodic stress score are tracked over time, the effects of the intervention activity on the periodic stress score may be visually presented to the end-user. As such, the end-user may track any progress that is made in lowering the period stress score. FIG. 8 shows a mobile device 800 including a display 802 visually presenting a GUI 806 including a visual representation of an effect of an intervention activity on the end-user's periodic stress score, in particular, GUI 806 includes a graph 808 indicating each instance of an intervention activity performed by the end-user over time. Further. GUI 806 includes a graph 810 indicating the end-user's periodic stress score over time. Graphs 808 and 810 are visually presented side-by-side such that the end-user may easily compare them and visualize the effects of the intervention activity on the periodic stress score. Graphs 808 and 810 are meant to be non-limiting, and mobile device 800 may visually represent the effects of the intervention activity on the periodic stress score in alternative forms.

Note that any of mobile device 600, wearable device 700, and mobile device 800 may be configured to perform some or all of the functionality described above.

In some implementations, sensor device(s) 318 of user device 302 may include a location sensor configured to determine a geographic location of user device 302. In some such implementations, stress assessment tool 340 may be configured to analyze the biometric data and the activity data of end-user 304 in combination with location data provided by the location sensor to identify geographic locations that affect the periodic stress score of end-user 304. For example, stress assessment tool 340 may be configured to identify geographic locations where the periodic stress score of end-user 304 is increased as as geographic locations where the periodic stress score of end-user 304 is decreased. Further, such location-based stress analysis may be tracked over time to provide recommendations for geographic locations that end-user should visit or avoid to decrease the periodic stress score of end-user 304.

FIG. 9 shows an example scenario in which geographic locations that affect an end-user's periodic stress score are visually presented on a mobile device 900. Mobile device 900 includes a display 902 configured to visually present a GUI 904 including a map 906. Map 906 may he any type of map, such as a street map or other topographical map. Map 906 includes a visual marker 908 indicating a current location of the mobile device 900. Further, map 906 includes visual markers 910 and 912 that indicate different stress-related locations. In particular, visual marker 910 indicates a geographic location in the form of a police station. The police station is a geographic location that is determined to increase the periodic stress score of the end-user based on analysis of biometric data and/or activity data of the end-user by the mobile device 900. Map 906 includes a recommendation 914 for the end-user to avoid the police station in order to not increase the periodic stress score of the end-user. Furthermore, visual marker 912 indicates a geographic location in the form of a yoga studio. The yoga studio is a geographic location that is determined to decrease the period stress score of the end-user based on analysis of biometric data and/or activity data of the end-user by the mobile device 900. Map 906 includes a recommendation 916 for the end-user to visit the yoga studio in order to decrease the periodic stress score of the end-user. Mobile device 900 may be configured to visually present visual markers associated with a stress-related geographic location. Moreover, the visual makers 910 and 912 and the recommendations 914 and 916 may take alternative forms.

The above-described scenario demonstrates one example aspect that affects the periodic stress score of the end-user. Other aspects that affect the periodic stress score of the end-user may be contemplated. In one example, the mobile device visually presents a summary including various people in different social relationships with the end-user. Each person may have a visual representation that indicates how that person affects the periodic stress score of the end-user. For example, the summary may indicate that sonic people increase the periodic stress score of the end-user and are therefore “stressful,” and other people are decrease the periodic stress score of the end-user and are therefore “relaxing.” In another example, the mobile device visually presents a summary including different projects (e.g., work, home improvement) that increase or decrease the periodic stress score of the end-user. Such summaries may be determined by the mobile device based on tracking of biometric data and activity data of the end-user over time, and applying such data to the machine-learning model of the stress assessment tool.

In some implementations, the mobile device may be configured to visually present recommendations for experiences based on a relative periodic stress score of the end-user. The relative periodic stress score may be a periodic stress score that differs from a “normal” or “baseline” (e.g., average) periodic stress score of the end-user, such as a relatively high score or a relatively low score. For example, if the end-user has a higher periodic stress score than normal, then the mobile device may recommend calming experiences, such as deep breathing, meditation, or yoga. In another example, if the end-user has a lower periodic stress score than normal, then the mobile device may notify the end-user of the condition and recommend that the end-use continue to perform the current activity to maintain a low periodic stress score over time.

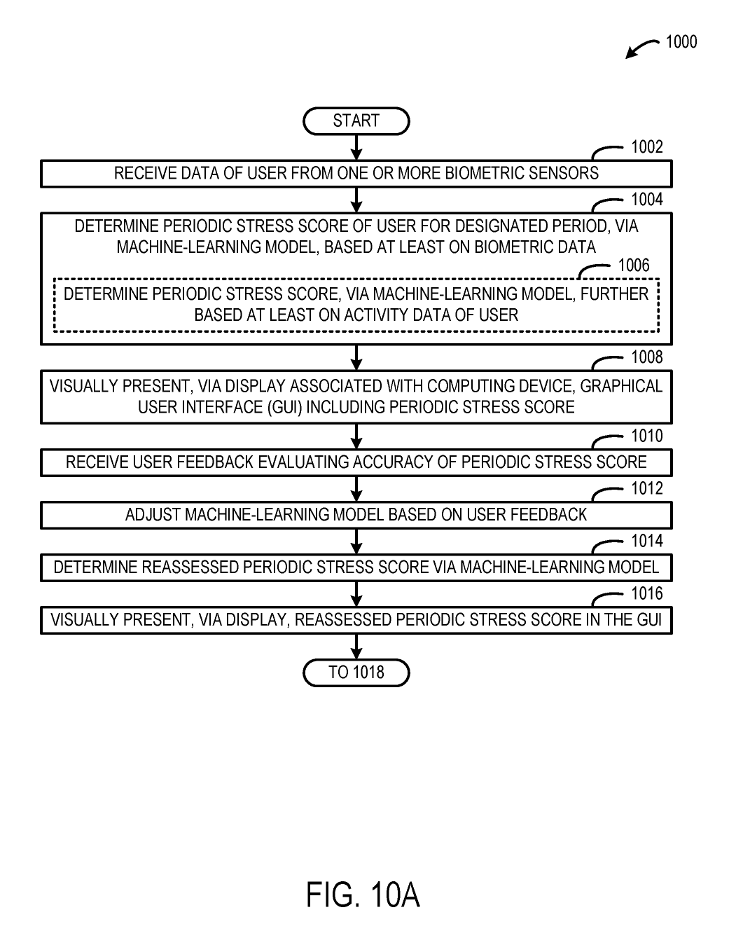

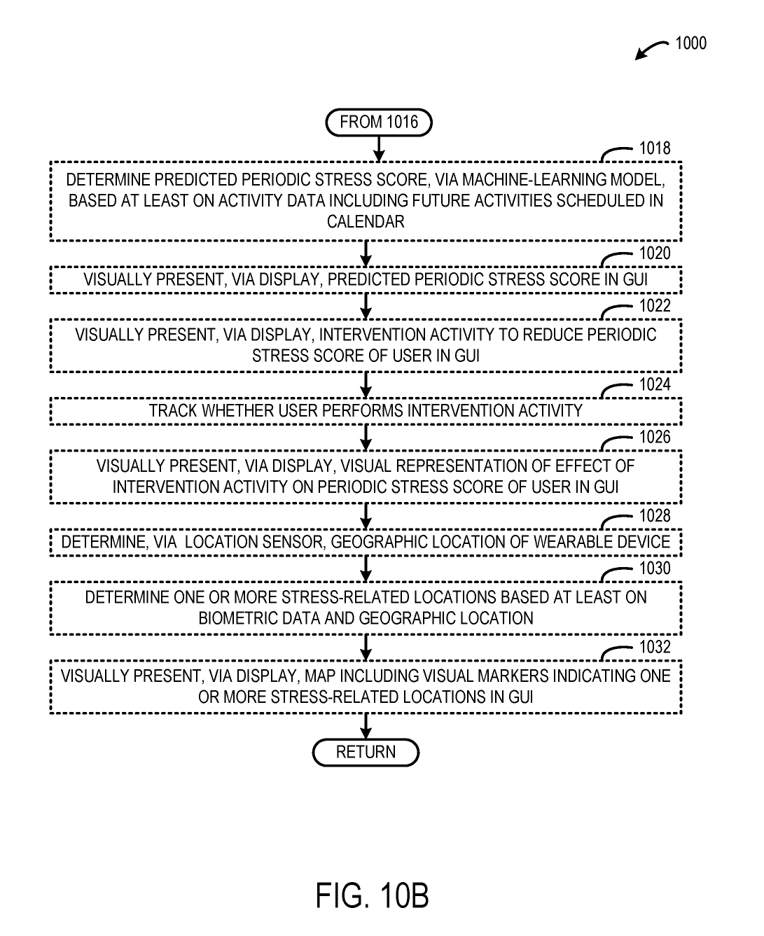

FIGS. 10A and 10B show an example method 1000 of providing a periodic stress score of an end-user. Method 1000 may be performed by a computing device in communication with one or more biometric sensors. For example, method 1000 may be performed by wearable device 100 of FIG. 1 wearable electronic device 10 of FIG. 2, user device 302 and/or wearable device 306 of FIG. 3, wearable device 400 and/or mobile device 406 of FIG. 4, mobile device 500 of FIG. 6, wearable device 600 of FIG. 6, mobile device 700 of FIG. 7, and mobile device 800 of FIG. 8.

In FIG. 10A, at 1002, method 1000 includes receiving biometric data of a user from one or more biometric sensors. In one example, the biometric sensors may be included in a wearable device worn by the user. In another example, the biometric sensors may be portable sensors that send biometric data of the user to the computing device. At 1004 method 1000 includes determining a periodic stress score of the user for a designated period, via a machine-learning model of the computing device, based at least on the biometric data. In some implementations, at 1006, method 1000 optionally may include determining the periodic stress score, via the machine-learning model, further based on activity data of the wearer. At 1008, method 1000 includes visually presenting, via a display associated with the computing device, a graphical user interface (GUI) including the periodic stress score. In one example, the display is located on a wearable device worn by the user. In another example, the display is located on a mobile device associated with the user, such as a smart phone. In another example, the display is included in a computing device that visually presents a health website. At 1010, method 1000 includes receiving user feedback evaluating the accuracy of the periodic stress score. In one example, the user feedback includes manual adjustment of the periodic stress score to a different periodic stress score that more accurately aligns with the perceived stress level of the user. At 1012, method 1000 includes adjusting the machine-learning model based on the user feedback. For example, the machine-learning model may include different features having different weights or coefficients, and one or more of the weights or coefficients may be adjusted based on the user feedback. At 1014, method 1000 includes determining a reassessed periodic stress score via the machine-learning model. At 1016, method 1000 includes visually presenting, via the display, the reassessed periodic stress score in the GUI.

In some implementations, the periodic stress score may be determined, via the machine-learning model, further based on activity data of the user including activities of the user scheduled in a calendar. In some such implementations, in FIG. 10B, at 1018, method 1000 optionally may include determining a predicted periodic stress score, via the machine-learning model, based at least on future activities scheduled in the calendar. At 1020, method 1000 optionally may include visually presenting, via the display, the predicted periodic stress score in the GUI.

In sonic implementations, at 1022, method 1000 optionally may include visually presenting, via the display, an intervention activity to reduce the periodic stress score of the user in the GUI. At 1024, method 1000 optionally may include tracking whether die user performs the intervention activity. At 1026, method 1000 optionally may include visually presenting, via the display, a visual representation of an effect of the intervention activity on the periodic stress score of the user in the GUI.

In some implementations, at 1028, method 1000 optionally may include determining, via a location sensor, a geographic location of the wearable device. At 1030, method 1000 optionally may include determining one or more stress-related locations based at least on the biometric data and the geographic location. At 1032, method 1000 optionally may include visually presenting, via the display, a map including visual markers indicating the one or more stress-related locations in the GUI.

The above described systems and methods offer the potential advantage of providing a periodic stress score that is tuned based on wearer feedback, such that the wearer's periodic stress score may be accurately assessed over time. Furthermore, because the periodic stress score is assessed over time, different intervention activities and location recommendations may be provided to the wearer in order to reduce the periodic stress score by forming healthy habits.

Wearable device 100 of FIG. 1, wearable electronic device 10 of FIG. 2, user device 302 and/or wearable device 306 of FIG. 3, wearable device 400 and/or mobile device 406 of FIG. 4, mobile device 500 of FIG. 6, wearable device 600 of FIG. 6, mobile device 700 of FIG. 7, mobile device 800 of FIG. 8 and described herein may take any suitable form. Each such computing device includes a processor, volatile memory, and non-volatile memory, as well as a display, input device, and communication system configured to enable the computing device to communicate with other devices via a computer network.

The processor of each computing device is configured to execute instructions that are part of one or more applications, programs, routines, libraries, objects, components, data structures, or other logical constructs. Such instructions may he implemented to perform a task, implement a data type, transform the state of one or more components, achieve a technical effect, or otherwise arrive at a desired result.

The processor of each device is typically configured to execute software instructions that are stored in non-volatile memory using portions of volatile memory. Additionally or alternatively, the processor may include one or more hardware or firmware processors configured to execute hardware or firmware instructions. Processors used by the devices described herein may be single-core or multi-core, and the instructions executed thereon may be configured for sequential, parallel, and/or distributed processing. Individual components of the processor optionally may be distributed among two or more separate devices, which may be remotely located and/or configured for coordinated processing. Aspects of the processor may be virtualized and executed by remotely accessible, networked computing devices configured in a cloud-computing configuration.

Non-volatile memory is configured to hold software instructions even when power is cut to the device, and may include optical memory (e.g., CD, DVD, HD-DVD, Blu-Ray Disc, etc.), solid state memory (e.g., EPROM, EEPROM, FLASH memory, etc.), and/or magnetic memory (e.g., hard-disk drive, floppy-disk drive, tape drive, MRAM, etc.), among others. Volatile memory is configured to hold software instructions and data temporarily during execution of programs by the processor, and typically such data is lost when power is cut to the device. Examples of volatile memory that may be used include RAM, DRAM, etc.

Aspects of processor, non-volatile memory, and volatile memory may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “engine,” “module,” and “program” may be used to describe an aspect of the herein described computing devices implemented to perform particular function. In some cases, an engine, module, or program may be instantiated via a processor executing instructions stored in non-volatile memory using portions of volatile memory at execution time. It will be understood that different engines, modules, and/or programs may be instantiated from the same application, service, code block, object, library, routine, API, function, etc., Likewise, the same engine, module, and/or program may be instantiated by different applications, services, code blocks, objects, routines, APIs, functions, etc. The terms “engine,” “module,” and “program” may encompass individual or groups of executable files, data files, libraries, drivers, scripts, database records, etc.

Each computing device may include an associated display, which may be used to present a visual representation of data computed and output by the processor. This visual representation may take the form of a graphical user interface (GUI). Such display devices may be combined with processor, volatile memory, and non-volatile memory in a shared enclosure, or such display devices may be peripheral display devices. Touch screens may be utilized that function both as a display and as an input device.

Each computing device may include a user input device such as a keyboard, mouse, touch pad, touch screen, microphone or game controller.

Each computing device may include a communication subsystem configured to communicatively couple the computing device with one or more other computing devices. The communication subsystem may include wired and/or wireless communication devices compatible with one or more different communication protocols. As non-limiting examples, the communication subsystem may be configured for communication via a wireless telephone or data network, or a wired or wireless local- or wide-area network. In sonic embodiments, the communication subsystem may allow the computing device to send and/or receive messages to and/or from other devices via a network such as the Internet.

In an example, a wearable device comprises one or more biometric sensors configured to determine biometric data of a wearer of the wearable device, and a stress assessment tool. The stress assessment tool is configured to determine a periodic stress score of the wearer for a designated period, via a machine-learning model, based at least on the biometric data, visually present, via a display associated with the wearable device, a GUI including the periodic stress score, receive wearer feedback evaluating the accuracy of the periodic stress score, adjust the machine-learning model based on the wearer feedback, determine a reassessed periodic stress score via the machine-learning model, and visually present, via the display, the reassessed periodic stress score in the GUI, In this example and/or other examples, the stress assessment tool may be configured to determine the reassessed periodic stress score at least once per day, and visually present, via the display, the reassessed periodic stress score in the GUI at least once per day. In this example and/or other examples, the periodic stress score may be selected from a scale of different, predetermined stress scores. In this example and/or other examples, the biometric data may include heart rate information. In this example and/or other examples, the periodic stress score may be determined, via the machine-learning model, further based on activity data of the wearer. In this example and/or other examples, the activity data may include one or more of sleep data, workout data, and calendar data. In this example and/or other examples, the activity data may include activities of the wearer scheduled in a calendar, and the stress assessment tool may be configured to determine a predicted periodic stress score, via the machine-learning model, based at least on future activities scheduled in the calendar, and visually present, via the display, the predicted periodic stress score in the GUI. In this example and/or other examples, the machine-learning model may be selected from a group consisting of a random decision forest regression model and a linear regression model. In this example and/or other examples, the wearer feedback may include manual adjustment of the periodic stress score to a different periodic stress score. In this example and/or other examples, the stress assessment tool may be configured to visually present, via the display, an intervention activity to reduce the periodic stress score of the wearer in the GUI, track whether the wearer performs the intervention activity, and visually present, via the display, a visual representation of an effect of the intervention activity on the periodic stress score of the wearer in the GUI. In this example and/or other examples, the wearable device may further comprise a location sensor configured to determine a geographic location of the wearable device, and the stress assessment tool may be configured to determine one or more stress-related locations based at least on the biometric data and the geographic location, and visually present, via the display, a map including visual markers indicating the one or more stress-related locations in the GUI.

In an example, a method of measuring a periodic stress score of a user with a computing device comprises receiving biometric data of the user from one or more biometric sensors determining a periodic stress score of the user for a designated period, via a machine-learning model, based at least on the biometric data visually presenting, via a display, a graphical user interface (GUI) including the periodic stress score, receiving user feedback evaluating the accuracy of the periodic stress score, adjusting the machine-learning model based on the user feedback, determining a reassessed periodic stress score via the machine-learning model, and visually presenting, via the display, the reassessed periodic stress score in the GUI. In this example and/or other examples, the periodic stress score may be determined, via the machine-learning model, further based on activity data of the user including activities of the user scheduled in a calendar, and the method may further comprise determining a predicted periodic stress score, via the machine-learning model, based at least on future activities scheduled in the calendar, and visually presenting, via the display, the predicted periodic stress score in the GUI. In this example and/or other examples, the method may further comprises visually presenting, via the display, an intervention activity to reduce the periodic stress score of the user in the GUI, tracking whether the user performs the intervention activity, and visually presenting, via the display, a visual representation of an effect of the intervention activity on the periodic stress score of the user in the GUI. In this example and/or other examples, the method may further comprise determining, via a location sensor, a geographic location of the user, determining one or more stress-related locations based at least on the biometric data and the geographic location, and visually presenting, via the display, a map including visual markers indicating the one or more stress-related locations in the GUI. In this example and/or other examples, the user feedback may include manual adjustment of the periodic stress score to a different periodic stress score.

In an example a wearable device comprises one or more biometric sensors configured to determine biometric data of a wearer of the wearable device and a stress assessment tool. The stress assessment tool is configured to receive activity data including activities of the wearer scheduled in a calendar, determine a periodic stress score of the wearer for a designated period, via a machine-learning model, based at least on the biometric data and the activity data, visually present, via a display associated with the wearable device, a graphical user interface (GUI) including the periodic stress score, determine a predicted periodic stress score, via the machine-learning model, based at least on future activities scheduled in the calendar, and visually present, via the display, the predicted periodic stress score in the GUI. In this example and/or other examples, the stress assessment tool may be configured to receive wearer feedback evaluating the accuracy of the periodic stress score, adjust the machine-learning model based on the wearer feedback, determine a reassessed periodic stress score, via the machine-learning model, and visually present, via the display, the reassessed periodic stress score in the GUI. In this example and/or other examples, the stress assessment tool may be configured to visually present, via the display, an intervention activity to reduce the periodic stress score of the wearer in the GUI, track whether the wearer performs the intervention activity, and visually present, via the display, a visual representation of an effect of the intervention activity on the periodic stress score of the wearer in the GUI. In this example and/or other examples, the wearable device may further comprise a location sensor configured to determine a geographic location of the wearable device, and the stress assessment tool may be configured to determine one or more stress-related locations based at least on the biometric data and the geographic location, and visually present, via the display, a map including visual markers indicating the one or more stress-related locations in the GUI.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device comprising:
one or more biometric sensors configured to determine biometric data of a wearer of the wearable device; and
a stress assessment tool configured to:
determine a periodic stress score of the wearer for a designated period, via a machine-learning model based at least on the biometric data,
visually present, via a display associated with the wearable device, a graphical user interface (GUI) including the periodic stress score,
receive wearer feedback evaluating the accuracy of the periodic stress score,
adjust the machine-learning model based on the wearer feedback,
determine a reassessed periodic stress score via the machine-learning model, and
visually present, via the display, the reassessed periodic stress score in the GUI.

2. The wearable device of claim 1, wherein the stress assessment tool is configured to determine the reassessed periodic stress score at least once per day, and visually present, via the display, the reassessed periodic stress score in the GUI at least once per day.

3. The wearable device of claim 1, wherein the periodic stress score is selected from a scale of different, predetermined stress scores.

4. The wearable device of claim 1, wherein the biometric data includes heart rate information.

5. The wearable device of claim 1, wherein the periodic stress score is determined, via the machine-learning model, further based on activity data of the wearer.

6. The wearable device of claim 5, wherein the activity data includes one or more of sleep data, workout data, and calendar data.

7. The wearable device of claim 5, wherein the activity data includes activities of the wearer scheduled in a calendar, and wherein the stress assessment tool is configured to:
determine a predicted periodic stress score, via the machine-learning model, based at least on future activities scheduled in the calendar, and
visually present, via the display, the predicted periodic stress score in the GUI.

8. The wearable device of claim 1, wherein the machine-learning model is selected from a group consisting of a random decision forest regression model and a linear regression model.

9. The wearable device of claim 1, wherein the wearer feedback includes manual adjustment of the periodic stress score to a different periodic stress score.

10. The wearable device of claim 1, wherein the stress assessment tool is configured to:
visually present, via the display, an intervention activity to reduce the periodic stress score of the wearer in the GUI,
track whether the wearer performs the intervention activity, and
visually present, via the display, a visual representation of an effect of the intervention activity on the periodic stress score of the wearer in the GUI.

11. The wearable device of claim 1, further comprising:
a location sensor configured to determine a geographic location of the wearable device; and
wherein the stress assessment tool is configured to:
determine one or more stress-related locations based at least on the biometric data and the geographic location; and
visually present, via the display, a map including visual markers indicating the one or more stress-related locations in the GUI.

12. A method of measuring a periodic stress score of a user with a computing device, the method comprising:
receiving biometric data of the user from one or more biometric sensors;
determining a periodic stress score of the user for a designated period, via a machine-learning model, based at least on the biometric data;
visually presenting, via a display, a graphical user interface (GUI) including the periodic stress score;
receiving user feedback evaluating the accuracy of the periodic stress score;
adjusting the machine-learning model based on the user feedback;
determining a reassessed periodic stress score via the machine-learning model; and
visually presenting, via the display, the reassessed periodic stress score in the GUI.

13. The method of claim 12, wherein the periodic stress score is determined, via the machine-learning model, further based on activity data of the user including activities of the user scheduled in a calendar, and wherein the method further comprises:
determining a predicted periodic stress score, via the machine-learning model, based at least on future activities scheduled in the calendar; and
visually presenting, via the display, the predicted periodic stress score in the GUI.

14. The method of claim 12, further comprising:
visually presenting, via the display, an intervention activity to reduce the periodic stress score of the user in the GUI;
tracking whether the user performs the intervention activity; and
visually presenting, via the display, a visual representation of an effect of the intervention activity on the periodic stress score of the user in the GUI.

15. The method of claim 12, further comprising:
determining, via a location sensor, a geographic location of the user;
determining one or more stress-related locations based at least on the biometric data and the geographic location; and
visually presenting, via the display, a map including visual markers indicating the one or more stress-related locations in the GUI.

16. The method of claim 12, wherein the user feedback includes manual adjustment of the periodic stress score to a different periodic stress score.

17. A wearable device comprising:
one or more biometric sensors configured to determine biometric data of a wearer of the wearable device: and
a stress assessment tool configured to:
receive activity data including activities of the wearer scheduled in a calendar,
determine a periodic stress score of the wearer for a designated period, via a machine-learning model, based at least on the biometric data and the activity data,
visually present, via a display associated with the wearable device, a graphical user interface (GUI) including the periodic stress score,
determine a predicted periodic stress score, via the machine-learning model, based at least on future activities scheduled in the calendar, and
visually present, via the display, the predicted periodic stress score in the GUI.

18. The wearable device of claim 17, wherein the stress assessment tool is configured to:
receive wearer feedback evaluating the accuracy of the periodic stress score,
adjust the machine-learning model based on the wearer feedback,
determine a reassessed periodic stress score, via the machine-learning model, and
visually present, via the display, the reassessed periodic stress score in the GUI.

19. The wearable device of claim 17, wherein the stress assessment tool is configured to:
visually present, via the display, an intervention activity to reduce the periodic stress score of the wearer in the GUI,
track whether the wearer performs the intervention activity, and
visually present, via the display, a visual representation of an effect of the intervention activity on the periodic stress score of the wearer in the GUI.

20. The wearable device of claim 17, further comprising:
a location sensor configured to determine a geographic location of the wearable device; and
wherein the stress assessment tool is configured to:
determine one or more stress-related locations based at least on the biometric data and the geographic location; and
visually present, via the display, a map including visual markers indicating the one or more stress-related locations in the GUI.
